(19) United States
(12) Patent Application Publication
(10) Pub. No.: US 2024/0109283 A1
(43) Pub. Date: Apr. 4, 2024

(54) Method for Automated Error Management in a Printing Machine

(71) Applicant: Windmöller & Hölscher KG, Lengerich (DE)

(72) Inventor: Martin Krümpelmann, Lengerich (DE)

(21) Appl. No.: 17/769,114

(22) PCT Filed: Oct. 14, 2020
(86) PCT No.: PCT/EP2020/078828

§ 371 Date: Apr. 14, 2022

(30) Foreign Application Priority Data
Oct. 16, 2019 (DE) 102019127996.8

(51) Int. Cl. B41F 33/00; B41F 5/24

(52) U.S. Cl. CPC B41F 33/0036; B41F 5/24

(57) ABSTRACT

The invention relates to a method for automated error management in a printing machine, wherein a recurring print image is imprinted on a moving material web. To improve automated error management for existing inspection systems, a method is provided wherein the print image is acquired by a line scan camera and forwarded to a control unit, in which a print error is recognized in the acquired print image, using an error recognition algorithm, and forwarded by the control unit to an error type database together with characteristics information. The error type database outputs the error type of the recognized print error in an implementation phase, the error type database having been trained by a plurality of operators in a training phase.

The invention relates to a method for automated error management in a printing machine, in which a recurring print image is imprinted on a moving material web.

In this context, error management refers to all actions taken to handle printing errors in the printing machine during the printing process. Error management typically includes three phases, namely error detection (i.e. the determination that an error is present), error diagnosis (i.e. allocation to a specific cause), and the actual error elimination.

So-called inspection systems are used to carry out error management in a printing machine. Such inspection systems are generally designed to enable the operator to observe and control the print image as a stationary image in the ongoing printing process on a monitor. The print image is typically acquired by a line scan camera. In contrast to an area scan camera, the line scan camera only acquires a single image line at a time since this allows for achieving a higher resolution and a higher readout speed compared to an area scan camera. The two-dimensional image is then created based on the movement of the conveyor. However, since this movement is subject to continuous fluctuations, the feed is synchronized via an encoder to prevent image distortions.

As an alternative or in addition to the line scan camera, the inspection system may also feature an area scan camera (also called matrix camera) that acquires a section of the print image on the moving material web. Synchronizing the area scan camera with the recurring print image ensures that a stationary image representing the selected section of the print image is displayed to the operator on the monitor of the control station. Preferably, the selected section is a distinctive area of the print image in which printing errors have a particularly relevant effect. The matrix camera is typically capable of zooming so that faulty or problematic areas of the print image may be examined in high resolution. If the operator detects printing errors in the displayed section (for example, color or register errors), the operator is in a position to readjust the machine parameters (for example the impression setting, the longitudinal register or the lateral register) to correct the printing errors.

Alternatively or in addition to the line scan camera and the area scan camera, the inspection system may further feature an optical spectrometer. An optical spectrometer breaks the light absorbed by a light point into its spectral components and evaluates the result in a computer system. Miniature spectrometers that are installed in a compact housing and may thus be placed in a suitable location within the printing machine are particularly suitable for the applications of the present invention. Such miniature spectrometers generally consist of an aperture (i.e. an entry gap), an optical grating, and an optical sensor. The grating is located behind the aperture and scatters the spectral components of the incident light at slightly varying angles, thus enabling the optical sensor to evaluate the scattered light as light intensity over the wavelength of the respective light components. Such an optical spectrometer is thus capable of monitoring the color components of a pixel within the print image during the printing process and of identifying deviations from a desired color result.

The positions of the errors detected by the operator on the moving material web are saved in the inspection system. After the completion of the printing process, it is then possible, for example with the aid of a rewinder, to move to, and separate the faulty portion of the imprinted material web. It is equally feasible to mark the faulty areas on the material web during printing and to discard them during subsequent processing. Furthermore, error recognition algorithms are known that are able to automatically recognize specific errors in the print image and to subsequently support the operator in fulfilling his tasks.

For example, an error recognition algorithm may be based on a reference image acquired at the start of the print order. For example, the reference image may be acquired via the line scan camera, the area scan camera, and/or the optical spectrometer at the start of the printing process based on the first print images (for example, the first 50 images), using a process in which these first images are integrated to create the reference image (also called “Golden Image”). In the integration phase, the fluctuation range of the image information may, for example, be determined for each individual pixel to set tolerance limits for error recognition. The currently acquired image is then subtracted from the reference image during the printing process. If the resulting difference is outside of the error tolerances, an error signal is generated, and the faulty image range is displayed on the control station monitor.

Alternatively or additionally, the desired print result may also be specified by means of the so-called digital proof provided by the prepress phase. To determine whether the print result meets the specifications, the image supplied by the inspection system is compared to the digital proof. The digital image processing techniques described above for the reference image may also be used for this comparison.

However, the above-described inspection systems and error recognition algorithms do not yet, or only to a minor extent, enable automatic error management in printing machines. Automatic error management in this context means that the printing machine operator is supported in all three phases of error management. Ideally, the automatic error management will even take over all actions that are required regarding a specific error in the printing machine.

The task of the invention is therefore to improve the automatic error management for existing inspection systems.

This task is solved by the characteristics of claim 1. Further preferred specific embodiments are given in the subclaims.

The attached drawings describe further details and advantages of the invention.

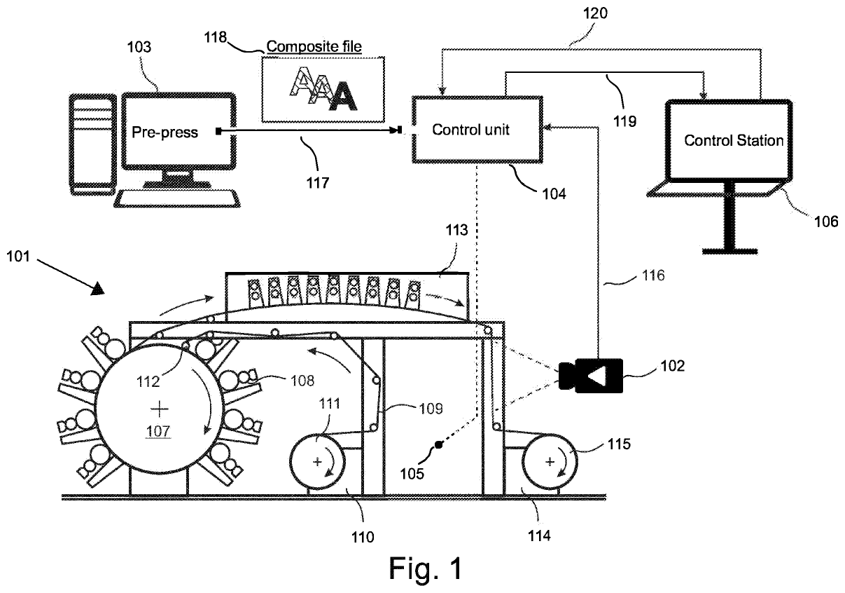

FIG. 1 shows an overall view of the printing machine according to the invention, using the example of a flexographic printing machine,

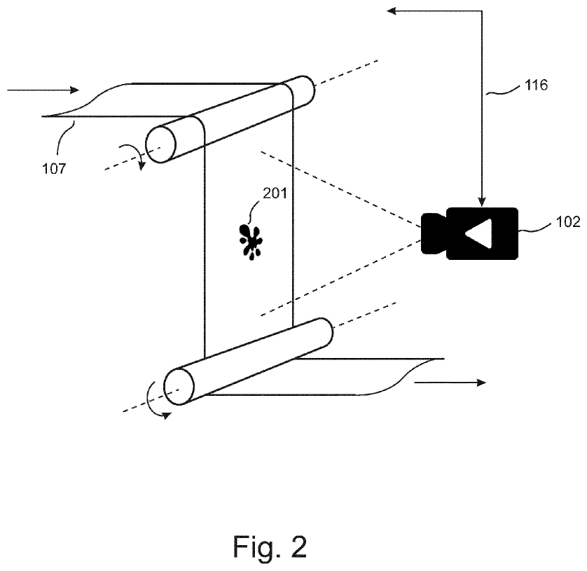

FIG. 2 shows a detail view of FIG. 1 including a line scan camera and a moving material web, and

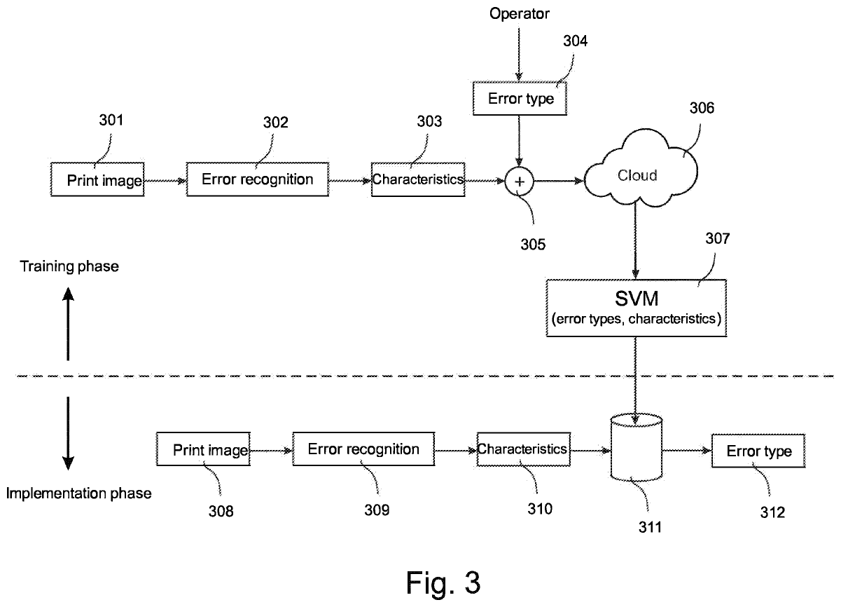

FIG. 3 shows a basic block diagram of the method according to the invention.

FIG. 1 shows an overall view of the printing machine according to the invention, using the example of a flexographic printing machine 101 having a line scan camera 102, a prepress phase 103, a control unit 104, and a control station 106. The control unit is installed at position 105 of the flexographic printing machine 101 and is shown separately for reasons of clarity.

The flexographic printing machine 101 is a so-called color impression machine and thus has a color impression drum 107 around which the eight color decks are installed in a satellite arrangement. Each of these color decks has a plate cylinder, an anilox mandrel and a doctor blade chamber, each of which are mounted on machine-side anchorages. Color deck 108 is labeled with the described components as an example of these eight color decks.

To imprint the material web 109, it is pulled off the material roll 111 in the unwinding station 110 and guided over several deflection rollers to the nip roller 112. The nip roller 112 places the material web 109 on the color impression drum 107 for further transport so that the material web 109 is moved with register accuracy past the color decks and the between-color dryers not shown in detail.

Once the material web 109 has left the color impression drum 107, it is moved through a bridge dryer 113 for drying the ink and is then wound onto the material roll 115 in the rewinding station 114.

The flexographic printing machine also features an inspection system for error recognition. For this purpose, an initial print image 118 (composite file) is saved together with the color separations from the prepress phase 103 in the control unit 104, the prepress phase being connected to the control unit 104 via the cable 117. The initial print image 118 is then compared to the actual print image acquired by the line scan camera 102 in the control unit 104, the line scan camera being connect to the control unit 104 via the cable 116.

FIG. 2 shows a detail view of FIG. 1 with a line scan camera and a moving material web. Since the corresponding reference signs were transferred from FIG. 1, reference should be made to the description of FIG. 1.

The method according to the invention is described by way of example in FIGS. 2 and 3. A distinction must be made between the training phase and the implementation phase, the implementation phase being explained first:

The material web moving out of bridge dryer 113 was imprinted by the color decks 108 and thus features a recurring print image. The print image is not shown in FIG. 2 for reasons of simplicity. The line scan camera 102 acquires the print image and forwards it to the control unit 104 via cable 116. An error recognition algorithm is implemented in the control unit 104 to recognize printing errors.

If the error recognition algorithm 309 recognizes a printing error in the print image 308, the print error is forwarded to an error type database 311 by the control unit, the print error including characteristics information 310. Examples of characteristics information include:
Position of the print error on the imprinted web
Shape of the print error (round, square, oval etc.)
Color of print error
Contrast of print error
Machine conditions to which the print error may be assignable, for example: Temperature of the impression cylinder, impression setting values, printing ink viscosity etc.

The error type database will then be able to output the error type 312 of the recognized print error in the implementation phase.

In the training phase, the error type database 311 is trained by a plurality of operators. The process is as follows:

The starting point of the training phase is the same situation of a print order, identical to the implementation phase. The training phase also involves the inspection of a print image 301 by an error recognition algorithm. However, if a print error is recognized in the training phase, the print error and the characteristics information 303 are displayed to the operator. Based on the displayed print error and the displayed characteristics information 303, the operator then decides which error type 304 has caused the print error. For logical reasons, the error types are hierarchically assigned to a plurality of categories. Examples of possible categories and error types include:
“Tonal value” category: Missing print, air inclusion, dot gain, dot loss, color error, etc.
“Streak” category: Streaks, plate edge, web wrinkle etc.
“Stain” category: Splashes, foreign bodies, impression of a damaged drum etc.
“Miscellaneous” category: Register error, moiré error, shading, image offset, image distortion, image error etc.

Terminal 305 then uploads the error type 304 entered by the operator together with the characteristics information 303 to a cloud data storage 306. The advantage of the cloud data storage 306 is that the cloud data storage 306 may be operated by a plurality of operators worldwide.

The data in the cloud data storage 306 are then analyzed and classified by a so-called Support Vector Machine (abbreviated: SVM). SVM 307 is a mathematical method of pattern recognition being implemented in a computer program. The principle of the SVM 307 is based on categorizing a data volume into classes such that a large margin around the class limits remains free of data (so-called “Large Margin Classifier”). Such an SVM is described, for example, in an article by Christopher J. C. Burges entitled “A Tutorial on Support Vector Machines for Pattern Recognition”, published in “Data Mining and Knowledge Discovery”, Volume 2/1998, pages 121-167.

If the SVM 307 identifies a region in the multidimensional characteristics space of characteristics 303, which was documented with sufficient frequency by the operator as the same error type 304, this results in a reproducible allocation between the characteristics 303 and the error type 304. This allocation is saved in database 311 by the SVM 307 in the training phase so that the database 3011 (sic) is able to output the trained error type 312 in the implementation phase based on the characteristics 310.

It is understood that the training phase and the implementation phase do not have to occur in sequence, but may be performed in parallel. In the implementation phase, it is also feasible to enable operators to make corrections if the error type 312 output by the database 311 does not appear correct to the operator.

List of reference signs

| | |
|---|---|
| 101 | Flexographic printing machine |
| 102 | Line scan camera |
| 103 | Pre-press phase |
| 104 | Control unit |
| 105 | Position of the flexographic printing machine |
| 106 | Control station |
| 107 | Color impression drum |
| 108 | Color deck |
| 109 | Material web |
| 110 | Unwinding station |
| 111 | Material roll |
| 112 | Nip roller |
| 113 | Bridge dryer |
| 114 | Rewinding station |
| 115 | Material roll |
| 116 | Cable |
| 117 | Cable |
| 118 | Initial print image |
| 301 | Print image |
| 302 | Error recognition algorithm |
| 303 | Characteristics information |
| 304 | Error type |
| 305 | Terminal |
| 306 | Cloud data storage |
| 307 | Support vector machine SVM |
| 308 | Print image |
| 309 | Error recognition algorithm |
| 310 | Characteristics information |
| 311 | Error type database |
| 312 | Error type |

1. Method for automated error management in a printing machine, the method comprising:
imprinting a recurring print image on a moving material web, acquiring by a line scan camera, the print image and forwarding the print image to a control unit,
recognizing, by the control unit a print error in the acquired print image using an error recognition algorithm and forwarding, by the control unit, the print error to an error type database together with characteristics information,
in an implementation phase, outputting, by the error type database, an error type of the recognized print error,
in a training phase, training the error type database is by a plurality of operators phase.

2. The method of claim 1, wherein the error type database is trained by a support vector machine in the training phase.

3. The method of claim 1, wherein the plurality of operators save data to a cloud storage in the training phase.
